(19) United States
(12) Patent Application Publication
(10) Pub. No.: US 2024/0094408 A1
(43) Pub. Date: Mar. 21, 2024

(54) SATELLITE (RE-)ACQUISITION AND STATE ESTIMATION FOR MOBILE FLAT-PANEL SATELLITE TERMINALS

(71) Applicant: Kymeta Corporation, Redmond, WA (US)

(72) Inventors: Navid Tadayon, Ottawa (CA); Bruce Rothaar, Woodinville, WA (US)

(21) Appl. No.: 18/367,395

(22) Filed: Sep. 12, 2023

Related U.S. Application Data
(60) Provisional application No. 63/408,016, filed on Sep. 19, 2022.

(51) Int. Cl. G01S 19/26

(52) U.S. Cl. CPC G01S 19/26

(57) ABSTRACT

Methods and apparatuses for performing state estimation and satellite re-acquisition for a mobile satellite terminal are described. In some embodiments, the apparatus comprising: a flat-panel antenna; and a signal processing engine communicably coupled to the flat-panel antenna configured to process asynchronous sensory inputs from a plurality of sensors and generate estimates of a state of a flat-panel antenna of the satellite antenna terminal based on the sensory inputs, wherein the estimates include an estimate of the orientation.

### RELATED APPLICATION

The present application is a non-provisional application of and claims the benefit of U.S. Provisional Patent Application No. 63/408,016, filed Sep. 19, 2022, and entitled “ESTIMATING THE STATE OF A MOBILE ANTENNA TERMINAL THROUGH TIGHT COUPLING OF INERTIAL, CLOSED-LOOP AND OPEN-LOOP SENSORY MEASUREMENT”, which is incorporated by reference in its entirety.

### FIELD OF THE DISCLOSURE

Embodiments of the present disclosure are related to wireless communication; more particularly, embodiments disclosed herein related to determining state information related to a satellite terminal and using that state information in order to perform action, such as, for example, re-acquisition of a satellite signal.

### BACKGROUND

Metasurface antennas have recently emerged as a new flat-panel antenna technology for generating steered, directive beams from a lightweight, low-cost, and planar physical platform. Such metasurface antennas have been recently used in a number of applications, such as, for example, satellite communication.

Metasurface antennas may comprise metamaterial antenna elements that can selectively couple energy from a feed wave to produce beams that may be controlled for use in communication. These antennas are capable of achieving comparable performance to phased array antennas from an inexpensive and easy-to-manufacture hardware platform.

Using a flat-panel antenna to produce beams in a particular direction requires knowing its orientation. The orientation is determined using data from sources such as sensors. However, the data from such sensors can be inaccurate for a number of reasons, such as, for example, the data rate of the sensors not matching when the time that data is needed to determine the orientation for the flat-panel antenna. Furthermore, at times, the data sources are not available. In such situations, the determination of the orientation is not as precise as necessary to efficiently operate the flat-panel antenna.

### SUMMARY

Methods and apparatuses for performing state estimation and satellite re-acquisition for a mobile satellite terminal are described. In some embodiments, the apparatus comprises: a flat-panel antenna; and a signal processing engine communicably coupled to the flat-panel antenna configured to process asynchronous sensory inputs from a plurality of sensors and generate estimates of a state of a flat-panel antenna of the satellite antenna terminal based on the sensory inputs, wherein the estimates include an estimate of the orientation.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates an exploded view of some embodiments of a flat-panel antenna.

FIG. 2 illustrates an example of a communication system that includes one or more antennas described herein.

FIG. 3 illustrates some embodiments of a sensor fusion engine.

FIG. 4 illustrates some other embodiments of a sensor fusion engine.

FIG. 5 illustrates some other embodiments of a sensor fusion engine.

FIG. 6 illustrates some embodiments of acceptance/rejection logic of a pre-processor.

FIG. 7 illustrates some embodiments of pre-processing logic employed by a pre-processor.

FIG. 8 illustrates some embodiments of logic for implementing each component in the GNSS pre-processing flow diagram of FIG. 7.

FIG. 9 illustrates some embodiments of an initializer estimator.

FIG. 10 illustrates use of frequency-domain filtering and time-domain thresholding as part of pre-processing data for some embodiments of core sensor fusion engine.

FIG. 11 illustrates an example of the data flow through some embodiments of a sensor fusion engine.

FIG. 12 illustrates some other embodiments of a core sensor fusion module.

FIG. 13 illustrates some embodiments of an anomaly detection component in the internal extended Kalman filter (EKF) to reject or accept certain data from within the sensor fusion process.

FIG. 14 shows the inputs and outputs of some embodiments of a post-processor.

FIG. 15 illustrates some embodiments of a post-processor rejecting or accepting estimates produces by the core sensor fusion engine.

FIG. 16 illustrates an apparatus having a sensor fusion engine in bi-directional communication with a (re)-acquisition engine.

FIG. 17 illustrates where the cone of uncertainty has resulted from the non-uniform belief that is obtained from the sensor fusion engine.

FIG. 18A illustrates using multiple simultaneous hypotheses from the hypothesis space and checks them simultaneously by forming multiple beams where each beam is formed based on an orientation hypothesis.

FIG. 18B illustrates an example of non-redundant searching performed by some embodiments of a re-acquisition engine.

FIGS. 18C and 18D illustrate some embodiments of a re-acquisition engine that uses gyroscope readings to propagate the rejected hypothesis forward in time to compensate for terminal motion while searching.

FIGS. 19A and 19B illustrate performing an intentional widening of the search uncertainty with the goal of exploiting the many-to-one relationship that exists between the orientation domain and the pointing domain.

FIG. 20 illustrates hierarchical adaptation of beam characteristic to shrink the beamwidth during searching.

FIGS. 21A-C illustrate adaptively adjusting the beam stride as more data becomes about the possible directions of the satellite.

### DETAILED DESCRIPTION

In the following description, numerous details are set forth to provide a more thorough explanation of embodiments of the present disclosure. It will be apparent, however, to one skilled in the art, that the teachings disclosed herein may be practiced without these specific details. In other instances, well-known structures and devices are shown in block diagram form, rather than in detail, in order to avoid obscuring the present disclosure.

Methods and apparatuses for estimating the state of a mobile satellite network terminal are disclosed. In some embodiments, the techniques disclosed herein estimate the state of a mobile satellite network terminal having an antenna. In some embodiments, the antenna is a flat-panel antenna (e.g., a metasurface antenna). In some embodiments, the estimation is performed using a tight coupling of inertial, closed-loop, and open-loop sensory measurement.

Furthermore, embodiments disclosed herein include a hybrid tight-coupling sensor fusion engine that can process sensory inputs from a multiplicity of asynchronous sensors of different rates. In some embodiments, the sensor fusion engine can generate an estimation of orientation and other state information for a moving satellite terminal (under simultaneous rotation and translation) as well as a stationary satellite terminal.

Moreover, methods and apparatuses for using the estimated state information are also described. The uses can include, for example, re-acquisition of a satellite signal by a satellite terminal after the signal has been lost post tracking. Other uses of the state information can be made by a satellite terminal.

The following disclosure discusses examples of antenna apparatus embodiments that can be part of terminals described herein, followed by details of estimating and using state of a mobile antenna terminal.

### Examples of Antenna Embodiments

The techniques described herein may be used with a variety of flat panel satellite antennas. Embodiments of such flat panel antennas are disclosed herein. In some embodiments, the flat panel satellite antennas are part of a satellite terminal. The flat panel antennas include one or more arrays of antenna elements on an antenna aperture.

In some embodiments, the antenna aperture is a metasurface antenna aperture, such as, for example, the antenna apertures described below. In some embodiments, the antenna elements comprise radio-frequency (RF) radiating antenna elements. In some embodiments, the antenna elements include tunable devices to tune the antenna elements. Examples of such tunable devices include diodes and varactors such as, for example, described in U.S. Patent Application Publication No. 20210050671, entitled “Metasurface Antennas Manufactured with Mass Transfer Technologies,” published Feb. 18, 2021. In some other embodiments, the antenna elements comprise liquid crystal (LC)-based antenna elements, such as, for example, those disclosed in U.S. Pat. No. 9,887,456, entitled “Dynamic Polarization and Coupling Control from a Steerable Cylindrically Fed Holographic Antenna”, issued Feb. 6, 2018, or other RF radiating antenna elements. It should be appreciated that other tunable devices such as, for example, but not limited to, tunable capacitors, tunable capacitance dies, packaged dies, micro-electromechanical systems (MEMS) devices, or other tunable capacitance devices, could be placed into an antenna aperture or elsewhere in variations on the embodiments described herein.

In some embodiments, the antenna aperture having the one or more arrays of antenna elements is comprised of multiple segments that are coupled together. In some embodiments, when coupled together, the combination of the segments form groups of antenna elements (e.g., closed concentric rings of antenna elements concentric with respect to the antenna feed, etc.). For more information on antenna segments, see U.S. Pat. No. 9,887,455, entitled “Aperture Segmentation of a Cylindrical Feed Antenna”, issued Feb. 6, 2018.

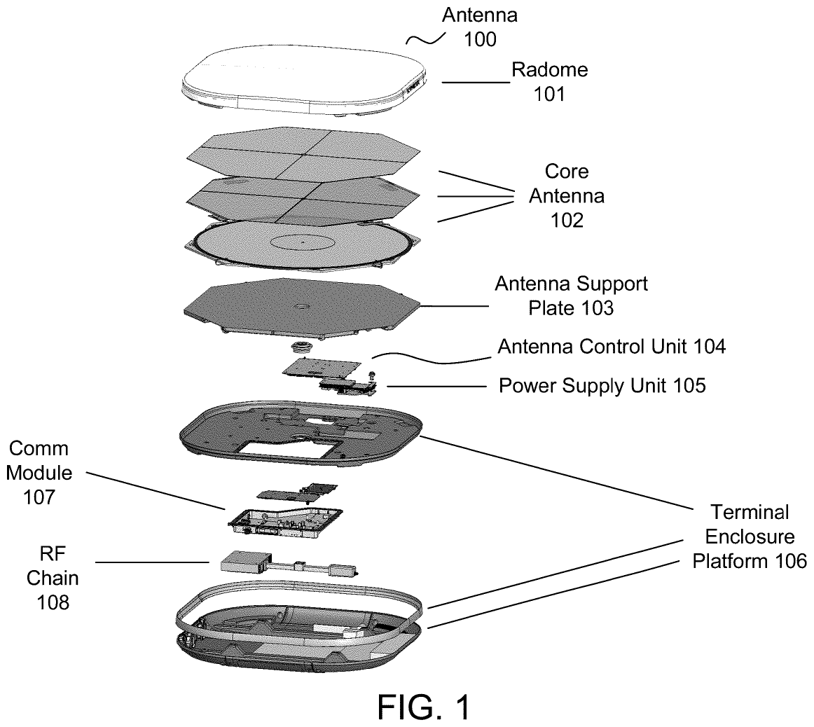

FIG. 1 illustrates an exploded view of some embodiments of a flat-panel antenna. Referring to FIG. 1, antenna 100 comprises a radome 101, a core antenna 102, antenna support plate 103, antenna control unit (ACU) 104, a power supply unit 105, terminal enclosure platform 106, comm (communication) module 107, and RF chain 108.

Radome 101 is the top portion of an enclosure that encloses core antenna 102. In some embodiments, radome 101 is weatherproof and is constructed of material transparent to radio waves to enable beams generated by core antenna 102 to extend to the exterior of radome 101.

In some embodiments, core antenna 102 comprises an aperture having RF radiating antenna elements. These antenna elements act as radiators (or slot radiators). In some embodiments, the antenna elements comprise scattering metamaterial antenna elements. In some embodiments, the antenna elements comprise both Receive (Rx) and Transmit (Tx) irises, or slots, which are interleaved and distributed on the whole surface of the antenna aperture of core antenna 102. Such Rx and Tx irises may be in groups of two or more sets where each set is for a separately and simultaneously controlled band. Examples of such antenna elements with irises are described in U.S. Pat. No. 10,892,553, entitled “Broad Tunable Bandwidth Radial Line Slot Antenna”, issued Jan. 12, 2021.

In some embodiments, the antenna elements comprise irises (iris openings) and the aperture antenna is used to generate a main beam shaped by using excitation from a cylindrical feed wave for radiating the iris openings through tunable elements (e.g., diodes, varactors, patch, etc.). In some embodiments, the antenna elements can be excited to radiate a horizontally or vertically polarized electric field at desired scan angles.

In some embodiments, a tunable element (e.g., diode, varactor, patch etc.) is located over each iris slot. The amount of radiated power from each antenna element is controlled by applying a voltage to the tunable element using a controller in ACU 104. Traces in core antenna 102 to each tunable element are used to provide the voltage to the tunable element. The voltage tunes or detunes the capacitance and thus the resonance frequency of individual elements to effectuate beam forming. The voltage required is dependent on the tunable element in use. Using this property, in some embodiments, the tunable element (e.g., diode, varactor, LC, etc.) integrates an on/off switch for the transmission of energy from a feed wave to the antenna element. When switched on, an antenna element emits an electromagnetic wave like an electrically small dipole antenna. Note that the teachings herein are not limited to having unit cell that operates in a binary fashion with respect to energy transmission. For example, in some embodiments in which varactors are the tunable element, there are 32 tuning levels. As another example, in some embodiments in which LC is the tunable element, there are 16 tuning levels.

A voltage between the tunable element and the slot can be modulated to tune the antenna element (e.g., the tunable resonator/slot). Adjusting the voltage varies the capacitance of a slot (e.g., the tunable resonator/slot). Accordingly, the reactance of a slot (e.g., the tunable resonator/slot) can be varied by changing the capacitance. Resonant frequency of the slot also changes according to the equation

$$f = \frac{1}{2 π \sqrt{LC}}$$

where f is the resonant frequency of the slot and L and C are the inductance and capacitance of the slot, respectively. The resonant frequency of the slot affects the energy coupled from a feed wave propagating through the waveguide to the antenna elements.

In particular, the generation of a focused beam by the metamaterial array of antenna elements can be explained by the phenomenon of constructive and destructive interference, which is well known in the art. Individual electromagnetic waves sum up (constructive interference) if they have the same phase when they meet in free space to create a beam, and waves cancel each other (destructive interference) if they are in opposite phase when they meet in free space. If the slots in core antenna 102 are positioned so that each successive slot is positioned at a different distance from the excitation point of the feed wave, the scattered wave from that antenna element will have a different phase than the scattered wave of the previous slot. In some embodiments, if the slots are spaced one quarter of a wavelength apart, each slot will scatter a wave with a one fourth phase delay from the previous slot. In some embodiments, by controlling which antenna elements are turned on or off (i.e., by changing the pattern of which antenna elements are turned on and which antenna elements are turned off) or which of the multiple tuning levels is used, a different pattern of constructive and destructive interference can be produced, and the antenna can change the direction of its beam(s).

In some embodiments, core antenna 102 includes a coaxial feed that is used to provide a cylindrical wave feed via an input feed, such as, for example, described in U.S. Pat. No. 9,887,456, entitled “Dynamic Polarization and Coupling Control from a Steerable Cylindrically Fed Holographic Antenna”, issued Feb. 6, 2018 or in U.S. Patent Application Publication No. 20210050671, entitled “Metasurface Antennas Manufactured with Mass Transfer Technologies,” published Feb. 18, 2021. In some embodiments, the cylindrical wave feed feeds core antenna 102 from a central point with an excitation that spreads outward in a cylindrical manner from the feed point. In other words, the cylindrically fed wave is an outward travelling concentric feed wave. Even so, the shape of the cylindrical feed antenna around the cylindrical feed can be circular, square or any shape. In some other embodiments, a cylindrically fed antenna aperture creates an inward travelling feed wave. In such a case, the feed wave most naturally comes from a circular structure.

In some embodiments, the core antenna comprises multiple layers. These layers include the one or more substrate layers forming the RF radiating antenna elements. In some embodiments, these layers may also include impedance matching layers (e.g., a wide-angle impedance matching (WAIM) layer, etc.), one or more spacer layers and/or dielectric layers. Such layers are well-known in the art.

Antenna support plate 103 is coupled to core antenna 102 to provide support for core antenna 102. In some embodiments, antenna support plate 103 includes one or more waveguides and one or more antenna feeds to provide one or more feed waves to core antenna 102 for use by antenna elements of core antenna 102 to generate one or more beams.

ACU 104 is coupled to antenna support plate 103 and provides controls for antenna 100. In some embodiments, these controls include controls for drive electronics for antenna 100 and a matrix drive circuitry to control a switching array interspersed throughout the array of RF radiating antenna elements. In some embodiments, the matrix drive circuitry uses unique addresses to apply voltages onto the tunable elements of the antenna elements to drive each antenna element separately from the other antenna elements. In some embodiments, the drive electronics for ACU 104 comprise commercial off-the shelf LCD controls used in commercial television appliances that adjust the voltage for each antenna element.

More specifically, in some embodiments, ACU 104 supplies an array of voltage signals to the tunable devices of the antenna elements to create a modulation, or control, pattern. The control pattern causes the elements to be tuned to different states. In some embodiments, ACU 104 uses the control pattern to control which antenna elements are turned on or off (or which of the tuning levels is used) and at which phase and amplitude level at the frequency of operation. The elements are selectively detuned for frequency operation by voltage application. In some embodiments, multistate control is used in which various elements are turned on and off to varying levels, further approximating a sinusoidal control pattern, as opposed to a square wave (i.e., a sinusoid gray shade modulation pattern).

In some embodiments, ACU 104 also contains one or more processors executing the software to perform some of the control operations. ACU 104 may control one or more sensors (e.g., a GPS receiver, a three-axis compass, a 3-axis accelerometer, 3-axis gyro, 3-axis magnetometer, etc.) to provide location and orientation information to the processor(s). The location and orientation information may be provided to the processor(s) by other systems in the earth station and/or may not be part of the antenna system.

Antenna 100 also includes a comm (communication) module 107 and an RF chain 108. Comm module 107 includes one or more modems enabling antenna 100 to communicate with various satellites and/or cellular systems, in addition to a router that selects the appropriate network route based on metrics (e.g., quality of service (QoS) metrics, e.g., signal strength, latency, etc.). RF chain 108 converts analog RF signals to digital form. In some embodiments, RF chain 108 comprises electronic components that may include amplifiers, filters, mixers, attenuators, and detectors.

Antenna 100 also includes power supply unit 105 to provide power to various subsystems or parts of antenna 100.

Antenna 100 also includes terminal enclosure platform 106 that forms the enclosure for the bottom of antenna 100. In some embodiments, terminal enclosure platform 106 comprises multiple parts that are coupled to other parts of antenna 100, including radome 101, to enclose core antenna 102.

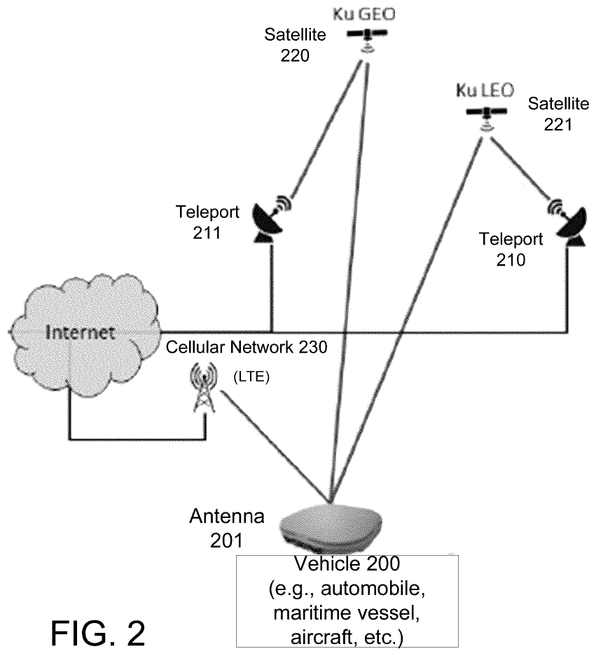

FIG. 2 illustrates an example of a communication system that includes one or more antennas described herein. Referring to FIG. 2, vehicle 200 includes an antenna 201. In some embodiments, antenna 201 comprises antenna 100 of FIG. 1. In some embodiments, vehicle 200 may comprise any one of several vehicles, such as, for example, but not limited to, an automobile (e.g., car, truck, bus, etc.), a maritime vehicle (e.g., boat, ship, etc.), airplanes (e.g., passenger jets, military jets, small craft planes, etc.), etc. Antenna 201 may be used to communicate while vehicle 200 is either on-the-pause, or moving. Antenna 201 may be used to communicate to fixed locations as well, e.g., remote industrial sites (mining, oil, and gas) and/or remote renewable energy sites (solar farms, windfarms, etc.).

In some embodiments, antenna 201 is able to communicate with one or more communication infrastructures (e.g., satellite, cellular, networks (e.g., the Internet), etc.). For example, in some embodiments, antenna 201 is able to communication with satellites 220 (e.g., a GEO satellite) and 221 (e.g., a LEO satellite), cellular network 230 (e.g., an LTE, etc.), as well as network infrastructures (e.g., edge routers, Internet, etc.). For example, in some embodiments, antenna 201 comprises one or more satellite modems (e.g., a GEO modem, a LEO modem, etc.) to enable communication with various satellites such as satellite 220 (e.g., a GEO satellite) and satellite 221 (e.g., a LEO satellite) and one or more cellular modems to communicate with cellular network 230. For another example of an antenna communicating with one or more communication infrastructures, see U.S. patent Ser. No. 16/750,439, entitled “Multiple Aspects of Communication in a Diverse Communication Network”, and filed Jan. 23, 2020.

In some embodiments, to facilitate communication with various satellites, antenna 201 performs dynamic beam steering. In such a case, antenna 201 is able to dynamically change the direction of a beam that it generates to facilitate communication with different satellites. In some embodiments, antenna 201 includes multi-beam beam steering that allows antenna 201 to generate two or more beams at the same time, thereby enabling antenna 201 to communication with more than one satellite at the same time. Such functionality is often used when switching between satellites (e.g., performing a handover). For example, in some embodiments, antenna 201 generates and uses a first beam for communicating with satellite 220 and generates a second beam simultaneously to establish communication with satellite 221. After establishing communication with satellite 221, antenna 201 stops generating the first beam to end communication with satellite 220 while switching over to communicate with satellite 221 using the second beam. For more information on multi-beam communication, see U.S. Pat. No. 11,063,661, entitled “Beam Splitting Hand Off Systems Architecture”, issued Jul. 13, 2021.

In some embodiments, antenna 201 uses path diversity to enable a communication session that is occurring with one communication path (e.g., satellite, cellular, etc.) to continue during and after a handover with another communication path (e.g., a different satellite, a different cellular system, etc.). For example, if antenna 201 is in communication with satellite 220 and switches to satellite 221 by dynamically changing its beam direction, its session with satellite 220 is combined with the session occurring with satellite 221.

Thus, the antennas described herein may be part of a satellite terminal that enables ubiquitous communications and multiple different communication connections.

### Estimating Terminal State

Methods and apparatuses for estimating state information of a terminal are disclosed. In some embodiments, the apparatus includes a flat-panel antenna and a sensor engine (e.g., a signal processing engine) communicably coupled to the flat-panel antenna. The sensor engine is configured to process asynchronous sensory inputs from multiple sources (e.g., sensors) and to generate estimates of a state of a flat-panel antenna of the satellite antenna terminal based on the sensory inputs. In some embodiments, the estimates of the state include an estimate of the orientation. In some embodiments, the state includes one or more of angular velocity, angular acceleration, linear acceleration, linear velocity, position, gyroscope bias, gyroscope noise statistics, accelerometer bias, accelerometer noise statistics, and accuracy indications regarding positional sensor.

In some embodiments, the techniques disclosed herein are operable to find the orientation of a terminal in a more accurate and robust manner. In some embodiments, the techniques disclosed herein are operable to find the orientation of a terminal with or without open-loop sensors.

One or more embodiments disclosed herein have one or more of the following advantages. First, embodiments disclosed herein perform their operations independent of open-loop sensors with erroneous and some unknown sources of error. Second, embodiments disclosed herein perform their operations with more precision and in a more robust manner than prior art techniques. Third, embodiments disclosed herein have the ability to update positional state of the user without having access to a global navigation satellite system (GNSS) or other global positioning systems (GPSs).

In some embodiments, the sensor engine (e.g., signal processing engine) includes a hybrid tight-coupling sensor fusion engine that can process sensory inputs from many asynchronous sensors (e.g., closed-loop sensors, open-loop sensors, etc.) of different rates to generate an estimation of orientation and/or other state information for a terminal. In some embodiments, the terminal can be a moving terminal (under simultaneous rotation and translation). In some other embodiments, the terminal can be a stationary terminal. In yet some other embodiments, the terminal can generate an estimation of orientation and/or other state information regardless of whether the terminal is moving or stationary. In some embodiments, the sensor engine is configured to generate the estimate of the orientation and/or other state information based on one or more of a velocity vector, positional vector, a differential position vector, and a differential velocity vector.

In some of embodiments, the sensory inputs processed by the sensor fusion engine includes one or more of inertial measurement units (IMU), the closed-loop (CL) measurements from one or more satellites of the same constellation, closed-loop (CL) measurements from one or more satellites of other constellations/orbits, the information about the historical position of the satellites, position and velocity of the terminal (e.g., GNSS-based position and velocity of the terminal, etc.), and moving-base real-time-kinematic (RTK) sensors. In some embodiments, the sensors can be turned on/off or have/not-have measurements with the sensor fusion engine adaptively adjusting its internal logic to accommodate itself to the varying number of asynchronous sensory measurements. For instance, in some embodiments, in a GNSS-denied environment where RTK and GNSS positional and velocity information are unavailable, the sensor fusion engine detects such a situation and processes the remaining set of sensory measurements that comprise a sufficient set to generate the state information. In some of embodiments, the determination of what constitutes the sufficient set is based on vetting of observability criteria.

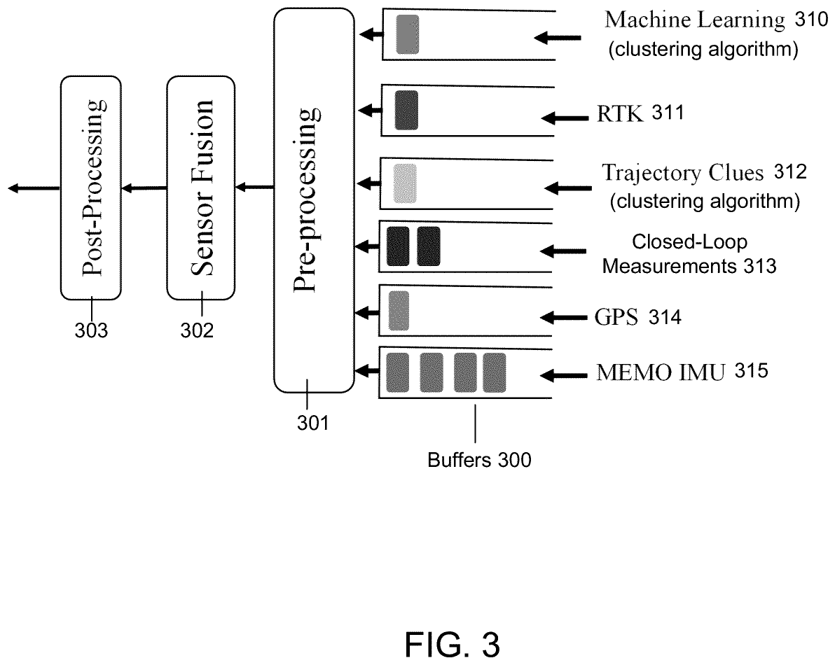

FIG. 3 illustrates a data flow diagram of some embodiments of a sensor fusion engine. In some embodiments, the sensor fusion engine is implemented by processing logic comprising hardware (e.g., circuitry, dedicated logic, etc.), software (e.g., software running on a chip, software run on a general-purpose computer system or a dedicated machine, etc.), firmware, or a combination of the three.

Referring to FIG. 3, buffers 300 receives and stores input data from one or more sources including sensor inputs. In some embodiments, the sources include a machine learning input 310, RTK 311, trajectory clues 312, closed-loop measurements 313, GPS 314 and signals from IMU 315. In some embodiments, the machine learning inputs 310 are from the output of a clustering algorithm such as described, for example, in more detail below herein. In some embodiments, trajectory clues inputs 312 are from an output of a Quest algorithm such as described, for example, in more detail below herein.

The inputs from buffers 300 are sent to pre-processing 301 that is performed by a pre-processor. Examples of preprocessing operations for one or more embodiments is disclosed herein. After preprocessing 301, the pre-processed data is forwarded to sensor fusion engine 302. In response to the data, sensor fusion engine generates the estimates of the state of the flat panel antenna. After generating the estimates, sensor fusion engine 302 sends the estimates to post-processing 303 that is performed by a post-processor. After the post-processing, the post-processed estimates are outputs.

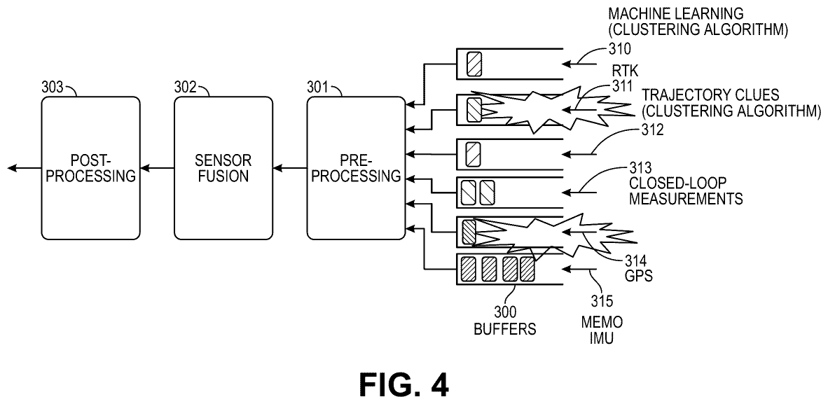

In some other embodiments, the sensor fusion engine can run only on CL measurements, satellite trajectory information, and IMUS or is run only on such data when the RTK and GPS data are not available. In some embodiments, this sensor fusion engine is used for GNSS-denied scenarios and use-cases. FIG. 4 illustrates some embodiments of a sensor fusion engine that operates even though it does not receive updated input from some of the data sources. Referring to FIG. 4, in this example, there is no updated data received from RTK 311 and GPS 314. Even so, in such a case, sensor fusion engine 302 continues to process the input data with the previously received input data for RTK 311 and GPS 314.

In some other embodiments, the GPS sensor generates several independent subsets of sensory input that are sent to, or otherwise provided to, the sensor fusion engine. In some embodiments, these include a velocity vector delivered directly by most GNSS receivers, a positional vector delivered directly by most GNSS receivers, and the differential position and differential velocity vectors that are calculated through some internal logic.

In some embodiments, the sensor fusion engine uses positional and velocity vectors as indirect clues to improve a final orientation estimate by first estimating the terminal acceleration, and also uses the aforementioned differential vectors as direct clues for estimation of orientation. Also, in some embodiments, the sensor fusion engine is configured to process the data from whichever GNSS sensor data is available at any given time. That is, the sensor fusion engine processes data from all of the GNSS sensors or only a partial set of data from GNSS sensors based on which of the GNSS sensors has data (e.g., recent data, new data, reliable data, etc.).

In some embodiments, the sensor fusion engine is configured to process CL measurements from one or more satellites from one or more constellations using RF, IF, and baseband metrics generated from signals received from the satellites in the same or different constellations in order to estimate the orientation of the terminal without the use of data from other external open-loop and/or inertial sensors.

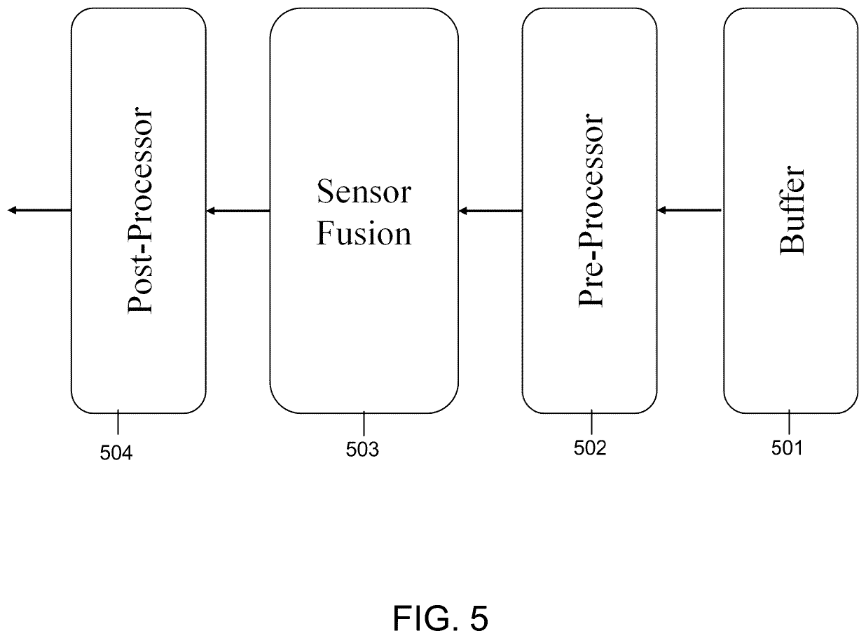

In some embodiments, the sensor fusion engine comprises three components: a pre-processor, a core fusion engine, and a post processor. FIG. 5 illustrates some embodiments of a sensor fusion engine. In some embodiments, the sensor fusion engine is implemented by processing logic comprising hardware (e.g., circuitry, dedicated logic, etc.), software (e.g., software running on a chip, software run on a general-purpose computer system or a dedicated machine, etc.), firmware, or a combination of the three.

Referring to FIG. 5, buffer 501 stores inputs to the sensor fusion engine as described herein. Preprocessor 502 performs preprocessing of the inputs stored in buffer 501. After preprocessing, the inputs are sent to core sensor fusion module 503 to generate estimates of the state of the antenna including its orientation. These estimates are output to post-processor 504 that performs post-processing on the estimates. The output of post-processor 504 is the post-processed estimates.

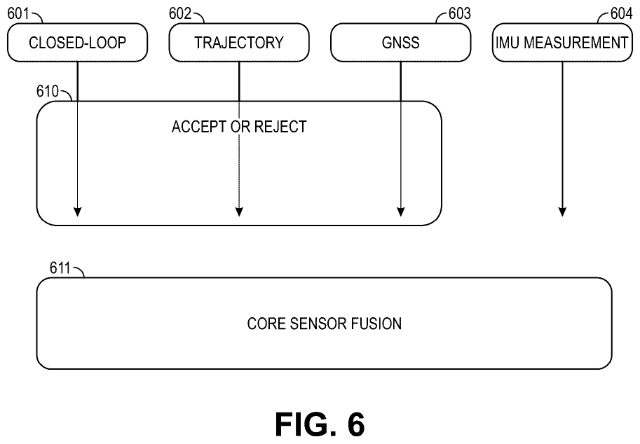

In some embodiments, pre-processor 502 receives sensory inputs from buffer 501 and determines which sensor measurements to deliver to the core fusion engine 503. In some of the embodiments, pre-processor 502 makes its determination by detecting the faulty sensors and outlier data based on several internal logics. An example of such an embodiment, is schematically shown by the acceptance/rejection logic of a pre-processor that accepts or rejects certain inputs as part of preprocessing in FIG. 6.

Referring to FIG. 6, according to some embodiments, the acceptance/rejection logic 610 of the preprocessing logic receives a number of inputs including closed-loop (CL) inputs 601, trajectory inputs 602 and GNSS inputs 603. Acceptance/rejection logic 610 determines whether to accept or reject the inputs from the sources. Acceptance/rejection logic 610 forwards the accepted data inputs to core sensor fusion 611 while preventing those inputs that are rejected from proceeding to core sensor fusion engine 611. As shown, IMU measurements 604 are sent, in some embodiments, directly sent, to the core sensor fusion 611 from the preprocessor without undergoing acceptance or rejection by the acceptance/rejection logic 610. In some other embodiments, IMU measurements 604 can be subject to acceptance/rejection via the acceptance/rejection logic that determines which to accept or reject based on the build quality of IMUS used. Note also that other inputs not shown in FIG. 6 can be subject to the acceptance/rejection logic 610 in some other embodiments.

In some embodiments, the IMU measurements are deemed the most reliable sensors, and hence, they may not be subject to any pre-processing acceptance/rejection logic. In such embodiments, the IMU measurements can be passed to sensor fusion engine 503.

In some other embodiments, pre-processor 502 makes its determination by detecting whether the data from sensors have all been collected from a time interval during which there has been no rotation (referred to herein as rotational stationary intervals) by the flat-panel antenna. For example, during such intervals, in some embodiments, the core fusion engine can deliver an estimate of gyro bias and other estimates related to other states of the system/sensors. In addition, pre-processor 502 detects the periods during which there has been no translation (referred to herein as translational stationarity intervals) by the flat-panel antenna so as to enable the core fusion engine to deliver an estimate of accelerometer bias as well as estimates for other states of the system. In some embodiments, the detection of rotational and translational stationarity is determined based on the magnitude and/or angular direction of the gyro readings, knowledge of gyro bias maximum magnitude, accelerometer reading and the knowledge of the magnitude and/or direction of the gravity vector.

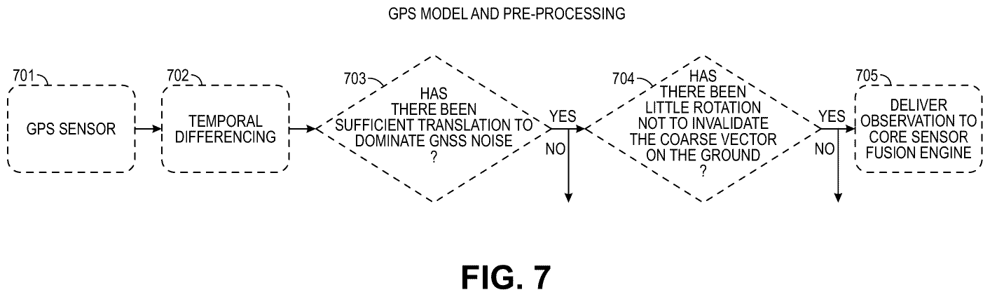

In some embodiments, pre-processor 502 processes the GNSS sensory information using a moving-window of historical gyro measurements to detect whether the aforementioned differential position and velocity vectors were established from an interval of rotational stationarity or not. If so, pre-processor 502 accepts the differential vectors for use in generating the orientation estimation and provides them to the sensor fusion engine. In some embodiments, pre-processor 502 includes the logic shown in FIG. 7. The velocity (and/or position) of the terminal at two different times are subtracted. The logic then compares the differential position/velocity vectors against some thresholds to determine whether the amount of displacement/velocity difference dominates the measurement noise on the base positional and velocity vectors. If the threshold is exceeded, then pre-processor 502 uses the gyro measurements collected from the interval of differencing to make sure no significant rotation has been undergone (which could invalidate the difference vectors). In some embodiments, if the terminal rotation is determined to be insignificant will pre-processor 502 send the differential measurements to the core fusion engine; otherwise, pre-processor 502 drops the differential measurements and does not allow them to be processed by the core fusion engine.

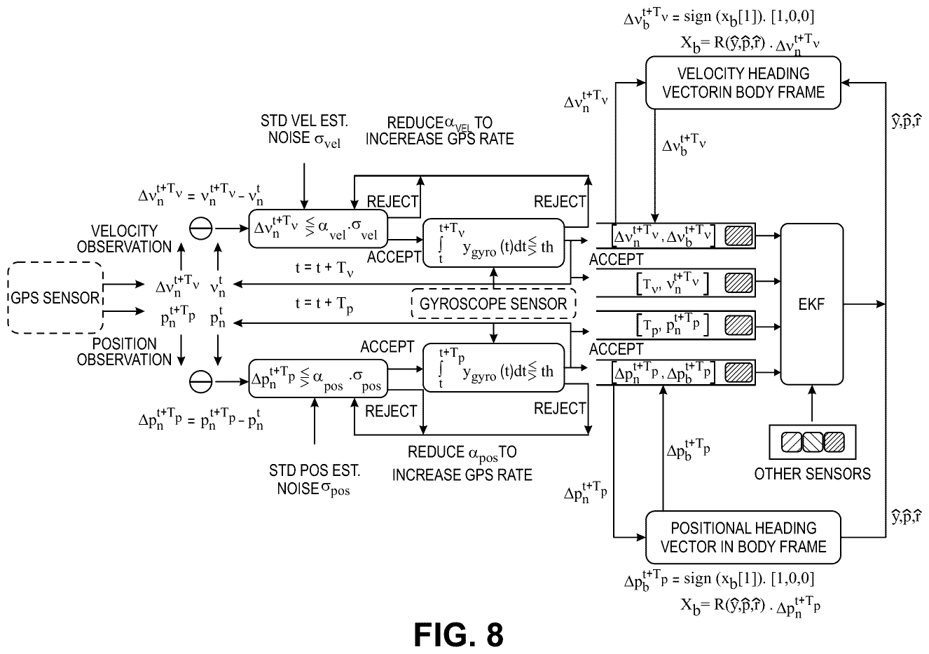

More specifically, referring to FIG. 7, GPS sensor 701 produces a GPS measurement. The GPS measurement is sent to temporal differencing module 702 which performs temporal differencing on the GPS measurement. The output of temporal differencing module 702 is sent to decision block 703 which determines whether there has been a sufficient translation to dominate the GNSS noise. If yes, then the data is forwarded for further processing. In not, the data is rejected, or the interval of temporal differencing is expanded. If there has been sufficient translation to dominate the GNSS noise, another decision block 704 determines whether there has been little rotation (so as to not invalidate the course vector on the ground). If not, then the data is rejected. If there has been little rotation so as to not invalidate the course vector on the ground, the observation is delivered to the core sensor fusion engine (block 705). FIG. 8 illustrates some embodiments of logic for implementing each component in the GNSS pre-processing flow diagram of FIG. 7.

In some other embodiments, pre-processor 502 processes the sensory measurements jointly (instead of individually) to not only detect anomalous sensory measurements, but also to detect anomalous situations in order to block the sensor fusion engine (and its EKF in some embodiments) from processing the anomalous observations in these situations. For instance, in some embodiments, pre-processor 502 identifies two non-anomalous vectors are substantially colinear at a certain time and prevents these substantially colinear, non-anomalous vectors from being sent to the sensor fusion engine as it is advantageous that they are not processed by the sensor fusion engine at that instance. As another example, when the satellite is overhead where the pointing vector is colinear with the gravity vector (in either reference frames), the collinearity of measurements collected from the accelerometer and the pointing vector can cause the sensor fusion engine to act incorrectly as having another colinear vector/measurement carry no extra information about the orientation of the terminal. This situation could occur to a LEO satellite passing overhead. In some embodiments, pre-processor 502 uses a cosine similarity metric between pointing and gravity vector to detect the collinearity scenario described above, and, in response to such a detection, pre-processor 502 limits the information sent to the sensor fusion engine so that the sensor fusion engine updates the orientation by integrating the gyro reading and freezes other states of the system.

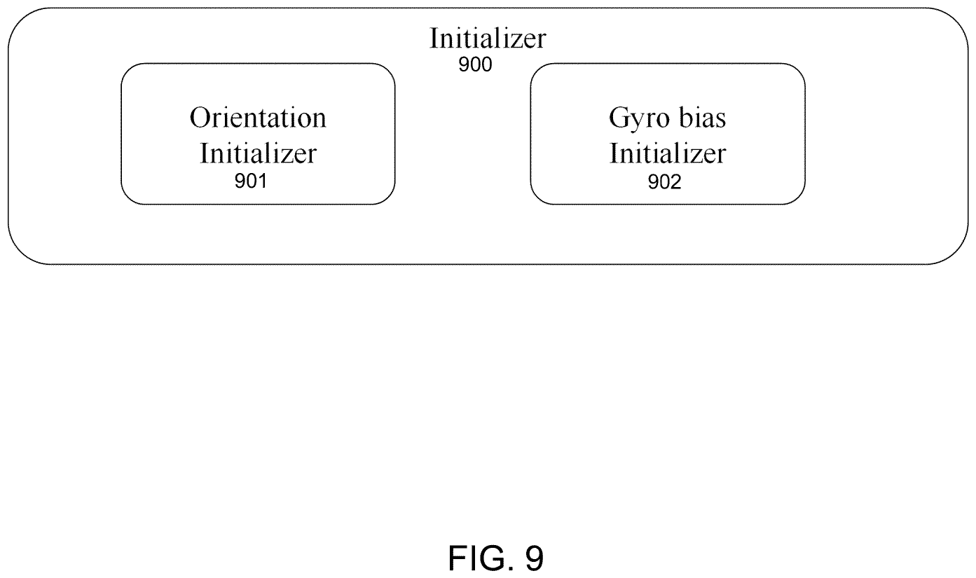

In some embodiments, the core fusion engine includes two general components, namely, the iterative fusion engines and an initializer estimator. The initializer estimator provides an initial guess to kickstart the processes performed by the iterative fusion engines. FIG. 9 illustrates some embodiments of an initializer estimator.

Referring to FIG. 9, initializer 900 includes orientation initializer 901 and gyro bias initializer 902. In some embodiments, the orientation initializer 901 includes an implementation of the QUEST algorithm, and the iterative fusion engine comprises an extended Kalman filter (EKF).

In some other embodiments, gyro bias initializer 902 of initializer 900 leverages a clustering algorithm in order to process historical gyro measurements to infer gyro bias of the gyroscope and use the latter as a good initialization point to kick off the iterative engine (of the sensor fusion engine). In some embodiments, the clustering algorithm is the Gaussian Mixture Model (GMM) based clustering algorithm or the K-means clustering algorithm. The use of either of these clustering algorithms obtains a good initial estimate of gyro bias when there are intermittent intervals of rotational stationarity. Even very brief bursts of rotational stationarity that are not distinguishable by the naked eye, but present in realistic motion captures, enable the precise estimation of gyro bias. In some embodiments, in the absence of such intervals (e.g., in maritime scenarios and stormy sea conditions), gyro bias initializer 902 sequentially and repeatedly executes frequency-domain filtering (to remove motion-related high-frequency components captured by the gyroscope) and time-domain thresholding (to remove motion-related low-frequency high-amplitude components captured by gyro) before inputting the processed gyro measurements to the clustering algorithms.

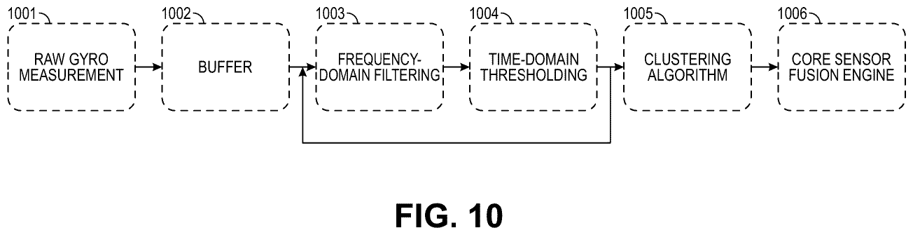

FIG. 10 illustrates use of frequency-domain filtering and time-domain thresholding as part of IMU pre-processing for some embodiments of core sensor fusion engine. Referring to FIG. 10, the raw gyro measurement 1001 is sent to buffer 1002. The buffered data in buffer 1002 undergoes frequency domain filtering 1003, and thereafter the filtered data undergoes time-domain thresholding 1004. Frequency domain filtering 1003 and time-domain thresholding 1004 can be repeated for finite number of times until desired confidence is achieved. The output of time-domain thresholding 1004 is forwarded to a clustering algorithm 1005. Clustering algorithm 1005 performs clustering as discussed in more detail below using one or more clustering algorithms. The output of the clustering algorithm 1005 is sent to the core sensor fusion engine 1006.

In some embodiments, the sensor fusion engine estimates several quantities on the 6 degrees of freedom of the terminal as well as the unknown parameters of the sensors at the input of the sensor fusion engine. In some embodiments, the sensor fusion engine estimates quantities that include one or more of angular velocity, orientation, angular acceleration, linear acceleration, linear velocity, position, gyroscope bias, gyroscope noise statistics, accelerometer bias, accelerometer noise statistics, positional sensor imperfections.

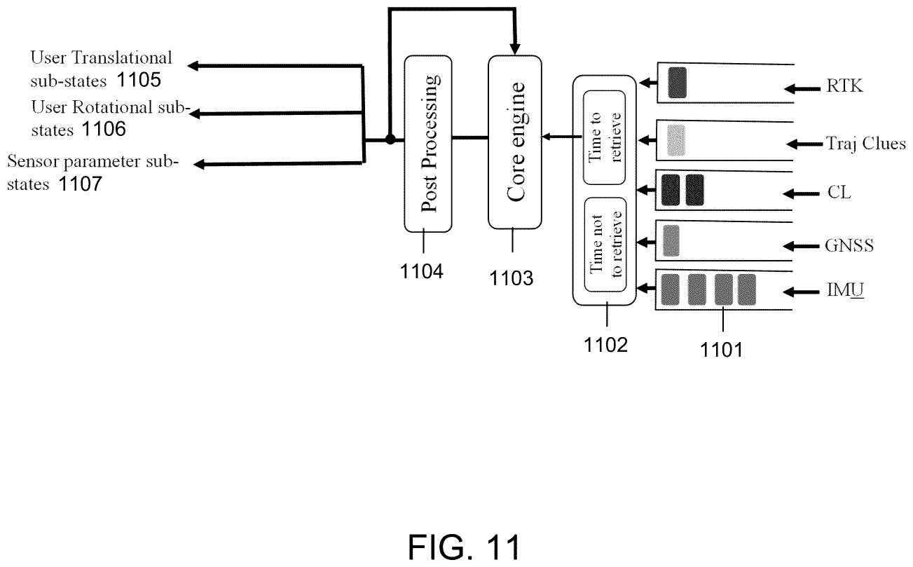

FIG. 11 illustrates an example of a data flow through some embodiments of a sensor fusion engine. In some embodiments, the sensor fusion engine is implemented by processing logic comprising hardware (e.g., circuitry, dedicated logic, etc.), software (e.g., software running on a chip, software run on a general-purpose computer system or a dedicated machine, etc.), firmware, or a combination of the three.

Referring to FIG. 11, the observation data including the sensory inputs are buffered using buffer 1101. Detection block 1102 determines for each of the inputs whether it is acceptable to retrieve a sufficient subset of observations from the input buffers or not. If such retrieval is permitted, then the corresponding measurements are provided to core engine 1103 that generates the estimates using an indication of whether new or older data is being used for the estimates. Core engine 1103 sends the generated estimates to post-processing 1104 (performed by a processor) with information related to whether the estimates were generated with older or up-to-date data. In some embodiments, the output of post-processing 1104 includes user translational sub-states 1105, user rotational sub-states 1106, and sensor parameter sub-states 1107.

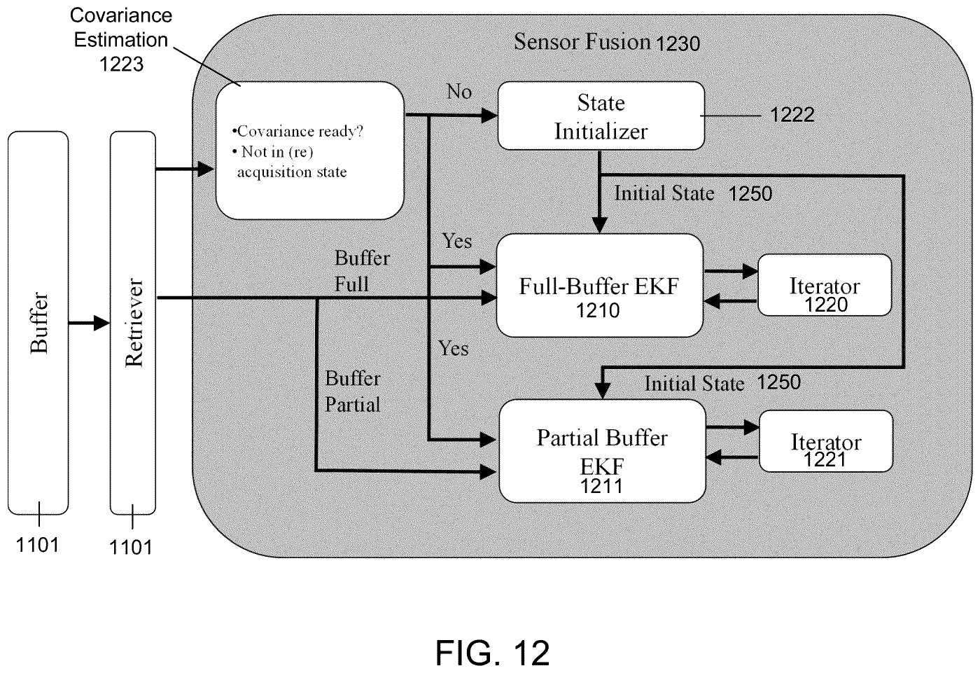

In some embodiments, the sensor fusion engine comprises multiple smaller engines that are activated depending on the availability and nature of the sensory inputs and the sufficiency of those inputs to estimate the outputs that represent the state of the terminal including its antenna. For example, in some embodiments, the multiple smaller engines include a full-buffer sensor fusion engine (e.g., full-buffer EKF 1210 of FIG. 12) and a partial buffer engine (e.g., partial buffer EKF 1211 of FIG. 12). When all observations are available, the full-buffer sensor fusion engine processes all the post-processed measurements at the same time to deliver a better estimate of the unknown state of the terminal. Due to a-synchronicity and multi-rate nature of different sensors, not all sensors deliver measurements at all fusion moments (e.g., each time the fusion engine is set to process measurement data, etc.). Given that it is often not desirable to restrict the estimation rate to the rate of the slowest sensor, the partial buffer engine is employed upon availability of a minimum set of measurements that constitute a sufficient set. This results in an increase to the estimation rate. In some embodiments, when no new observation is available, the last set of observations are repeatedly shown to the full-buffer and partial buffer sensor fusion engines so as to improve the accuracy of the estimate, which is shown in FIG. 12 by the iterator blocks 1220 and 1221, respectively. This is due to the fusion algorithm being run by the core sensor fusion operating as an iterative optimizer (as opposed to one-shot optimizer) that slowly converges to an optimal solution, thereby benefitting from seeing the most recent data set given sufficient time and processing speed until new data is available.

FIG. 12 illustrates some embodiments of a core sensor fusion engine. In some embodiments, the sensor fusion engine is implemented by processing logic comprising hardware (e.g., circuitry, dedicated logic, etc.), software (e.g., software running on a chip, software run on a general-purpose computer system or a dedicated machine, etc.), firmware, or a combination of the three.

Referring to FIG. 12, buffer 1201 stores the observations including the measurement inputs from sensors and other data sources. Retriever 1202 is coupled to buffer 1201 to retrieve the data and provide retrieved data to core sensor fusion 1230. Core sensor fusion engine 1230 includes a full buffer EKF 1210 and a partial buffer EKF 1211. In some embodiments, full-buffer EKF 1210 is used when there is a full buffer of new observation data available to the core sensor fusion 1230, while partial buffer EKF 1211 is used when the buffer 1201 does not include a full set of new observation data. Full-buffer EKF 1210 and partial buffer EKF 1211 can also operate in response to receiving initial state data 1250 from state initializer 1222.

Iterators 1220 and 1221 cause full-buffer EKF 1210 and partial buffer EKF 1211, respectively, to iterate on the data that is presented to them from buffer 1201, via retriever 1202. In some embodiments, whether full-buffer EKF 1210 and partial buffer EKF 1211 iterate using data from buffer 1201 or initial state 1250 from state initializer 1222 is based on whether the covariance is determined to be ready by covariance estimation block 1223. If the covariance is not ready, full-buffer EKF 1210 and partial buffer EKF 1211 iterate using the initial state 1250. If the covariance is determined to be ready, such that the data is in an acquisition state and at least some new data is made available to core sensor fusion 1230, then full-buffer EKF 1210 and/or partial buffer EKF 1211 iterate using data received from buffer 1201.

In some embodiments, the core fusion engine includes an extended Kalman filter (EKF) to estimate the unknown states of the system. In some embodiments, the Kalman gain of the EKF is adaptively adjusted based on “innovation statistics” as well as some external information obtained about sensors, probable states of the system, the motion limitations of the platform, and so on. For instance, if the IMU is known to be of less-accurate nature (as is the case in consumer-grade IMUs), the innovation statistics are adjusted by putting less emphasis on IMU measurements.

In some other embodiments, the core fusion engine adaptively adjusts the process covariance depending upon how reliable the prior knowledge about the state of the terminal is at two different time-steps when the core fusion engine previously performed iterations. For instance, for industrial-grade IMUs, the gyroscope bias is highly stable with little variation due to environmental changes. As a result, in some embodiments, it is better to choose the covariance (uncertainty) of gyro bias in the process model conservatively to increase reliance on gyroscope. Alternatively, for a consumer-grade IMU where no factory calibration is applied to the sensors, in some embodiments, the covariance uncertainty is widened to de-emphasize reliance on the less reliable sensor. This same concept can be applied to other states of the system. For instance, in some embodiments, if there exists some side information that indicates that the terminal is not rotating at this time, the covariance of orientation is reduced to give confidence to the fusion engine and reduce reliance on noisy observations.

In some other embodiments, the initial covariance of the state is chosen depending on a use case. Similar to the adaptive selection of process covariance discussed above, in some embodiments, the initial covariance of the system state is chosen to strike a balance between the speed of convergence and avoidance from divergence. As a general guideline, in some embodiments, the fusion process is kickstarted with a given state of the system with more uncertainty (larger covariance) when the value to be estimated is larger than expected, when there is lack of sufficiently elaborate modeling present in the system (e.g. when there is vibration in the system but it is intentionally ignored, or when GPS sensors has deteriorations from multipath which modeling is painstaking), or when the system suffers from an observability problem where not enough observations are available for a brief (and transient) interval of time.

In some embodiments, the full-buffer EKF 1210 in FIG. 12 is used to estimate all or some of the states during iterations where it was used. The nature of estimated state depends not only on sensor availability but also the inputted data corresponding to periods of stationarity. In some embodiments, the partial-buffer EKF 1211 in FIG. 12 is used to estimate only a subset of the unknown states. The initial state 1250 in FIG. 12 is an optional component of the core sensor fusion engine that causes the full-buffer EKF and/or the partial buffer EKF to process the same data over and over (until new data comes in) in order to improve the convergence properties of the estimate. In some embodiments, the iterators 1220 and 1221 in FIG. 12 can be used to take advantage of the core information processor being an iterative filter that may not have converged to the optimal solution if the parameters of the system are chosen such that the step-sizes towards optimal point are small. When this is the case, the iterators 1220 and 1221 in FIG. 12 leverages the higher speed of processor (compared to the lower information rate of the sensors) to improve the accuracy of the estimate at each epoch.

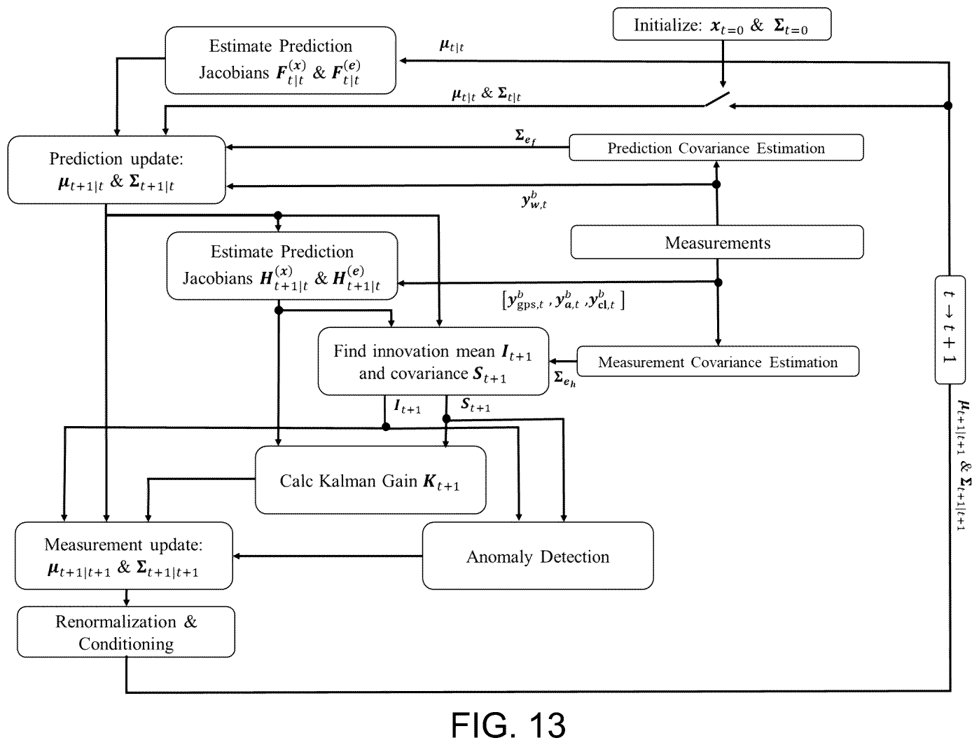

In some other embodiments, the core sensor fusion 1230 also internally checks whether to accept or reject one or more of the sensory inputs in the middle of the fusion process. As discussed above, the pre-processor determines the acceptance and rejection of the data from certain sensors prior to being sent to the core sensor fusion 1230 by inspecting sensor behavior individually or in conjunction with each other. However, rejection and acceptance of the use of data from certain sensors in the middle of the fusion by core sensor fusion 1230 uses the metrics such as, for example, innovation mean and innovation covariance of the filter, to determine which sensors are possibly inaccurate, and hence, better to be temporarily excluded from the remaining steps of fusion. FIG. 13 illustrates some embodiments of an anomaly detection component in the internal EKF to reject or accept certain data from within the sensor fusion process.

Referring back to FIG. 5, post-processor 504 performs post processing in the sensor fusion process. In some embodiments, post-processor 504 applies internal logic on updated estimates of state-space of the sensor fusion engine to decide whether they comply with the expected behavior or not. Thus, in some embodiments, post-processor 504 determines whether there are anomalies in the estimates generated by core sensor fusion module 503. An estimate can become anomalous for multiple reasons, some of which are: (1) anomalous sensor input passing through the pre-processing filter undetected, (2) core sensor fusion tracing a local minimum of the cost function than the global minimum, (3) the core sensor fusion processing asynchronous observations that capture state of the system at different times, (4) sensor outages that occur due to overheating (5) numerical errors, etc. Once any of these occur, post-processor 504 uses some internal logic in the post-processing operation to identify the occurrence and take action.

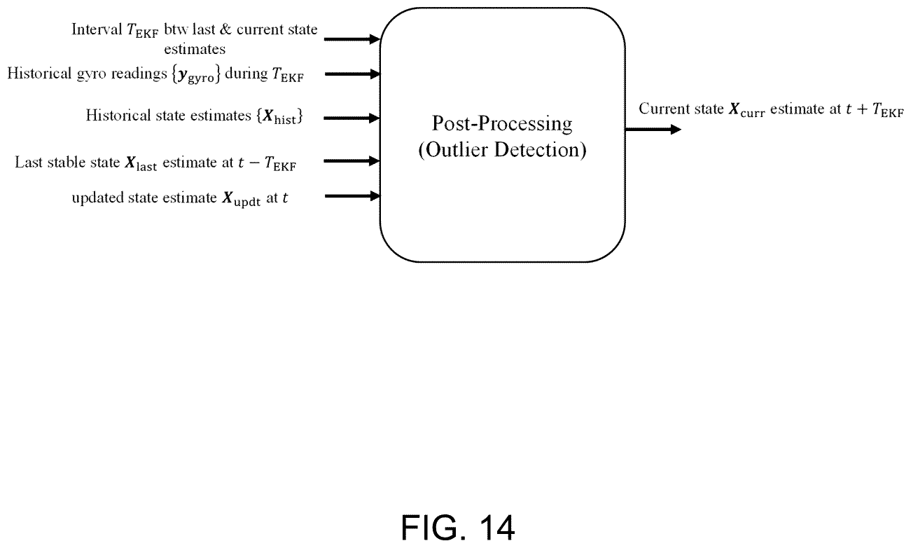

FIG. 14 shows the inputs and outputs of some embodiments of a post-processor (e.g., processor). In some embodiments, the inputs include an indication of the time interval between when the last estimate of the state and the current estimate of the state occurred, historical gyro readings during that interval, historical state estimate information, the last (previous) estimate of the state, and the updated (new) estimate of the state. Using outlier detection logic, the post-processor determines if there are outliers and outputs an indication of the current state based on whether or not the current state appears to be an anomaly.

Referring back to FIG. 5, in some other embodiments, other information can be used by post-processor 504. For example, in some embodiments, post-processor 504 uses the moving platform side-information such as platform type, its size, its maximum possible velocity/acceleration, the terrain in which it is going to maneuver, etc. to rule out the impossible translational motion sub-states of the system.

In yet some other embodiments, post-processor 504 uses the specification of sensors, such as, for example, the gyro and accelerometer, as the basis to infer accuracy level of the estimates of the sub-state of the fusion engine that is related to those unknown parameters related to the sensors such as, for example, bias and noise. For instance, in some embodiments, post-processor 504 rejects an EKF estimate for the gyroscope, which has a bias instability that is not expected to exceed a tenth of a degree per second (dps), if the estimate violates the expectation.

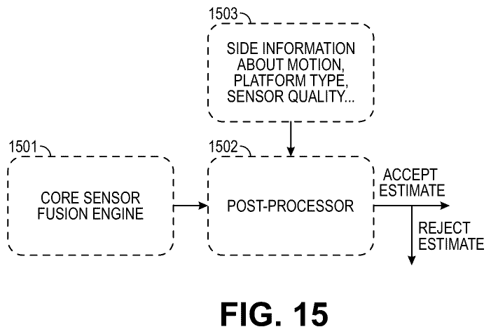

FIG. 15 illustrates some embodiments of a post-processor rejecting or accepting estimates produces by the core sensor fusion engine. Referring to FIG. 15, core sensor fusion engine 1501 provides estimates to post-processor 1502. Post-processor 1502 also receives side information 1503 about the motion platform type, sensor quality, etc. Based on this information, post processor 1502 decides whether to accept or reject estimates from core sensor fusion engine 1501.

### (Re-)Acquisition

In some embodiments, a re-acquisition engine is used to find the satellite in response to a loss of tracking. The loss of tracking can occur for several reasons. First, in some cases, the information rate of sensory measurements is slower than needed to estimate the unknown state of the sensor fusion or not fast enough to keep the beam on the satellite all the times. This lack of current information can occur when severe terminal motion is present.

Second, the moving terminal's lock on the satellite is lost due to a long satellite blockage (e.g., a tunnel, mast blockage, tree canopy, etc.). Nonetheless, it is crucial to be able to reestablish connectivity to the lost satellite as fast as possible when the blockage clears. Given that the knowledge of the orientation state of terminal plays a critical role in reestablishing the connectivity, and, depending on the type and duration of blockage/outage, the orientation may not be known with the needed accuracy, and thus, a re-acquisition search will be initiated to find the satellite.

Third, when connected to a non-geostationary satellite (such as, for example, emerging LEO constellations) where a handoff (HO) from a current diminishing serving satellite to the next emerging target satellite requires a very precise and frequent knowledge of orientation, and such a requirement might not be met temporarily by the sensor fusion engine.

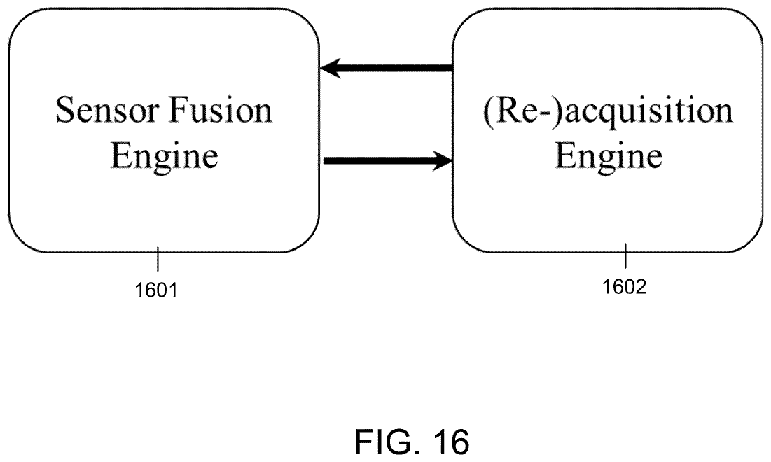

In some embodiments, to handle all these three situations where a loss of tracking has occurred, a re-acquisition engine is employed that uses a searching algorithm to facilitate availability and meet connectivity requirements. FIG. 16 illustrates an apparatus having a sensor fusion engine in bi-directional communication with a (re)-acquisition engine. Referring to FIG. 16, sensor fusion engine 1601 is coupled with (re-)acquisition engine 1602 where data is exchanged between them bidirectionally.

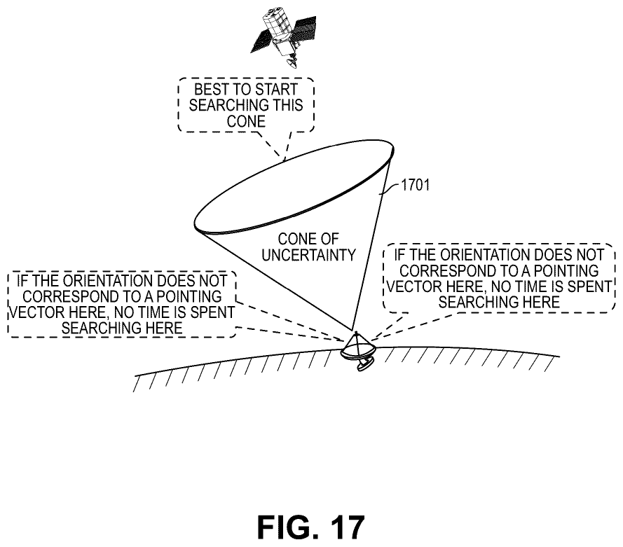

In some embodiments, the re-acquisition engine utilizes the estimated statistics of the state-space of the sensor fusion engine to perform a more intelligent and quicker search. For instance, in some embodiments, when the EKF in the core fusion engine is used, the mean and covariance of orientation can be exploited to draw orientation hypotheses and search the sky using the non-uniform Gaussian belief (a.k.a. hypothesis space) that the EKF delivers. FIG. 17 illustrates where the cone of uncertainty has resulted from the non-uniform belief that is obtained from the sensor fusion engine. Referring to FIG. 17, due to presence of some data or inference generated by the sensor fusion engine in the immediate past, there are some impossible regions that are avoided in order to shorten the outage time spent during sky search. Thus, a search space for searching the sky for a satellite is narrowed based on information generated by the sensor fusion engine. Particularly, the search space is limited to the areas where the orientation corresponds to a pointing vector generated by the sensor fusion engine. If the orientation does not correspond to a pointing vector, the search is not undertaken there. Thus, the search is narrowed to a cone of uncertainty 1701, which indicates the best area to start searching for re-acquisition.

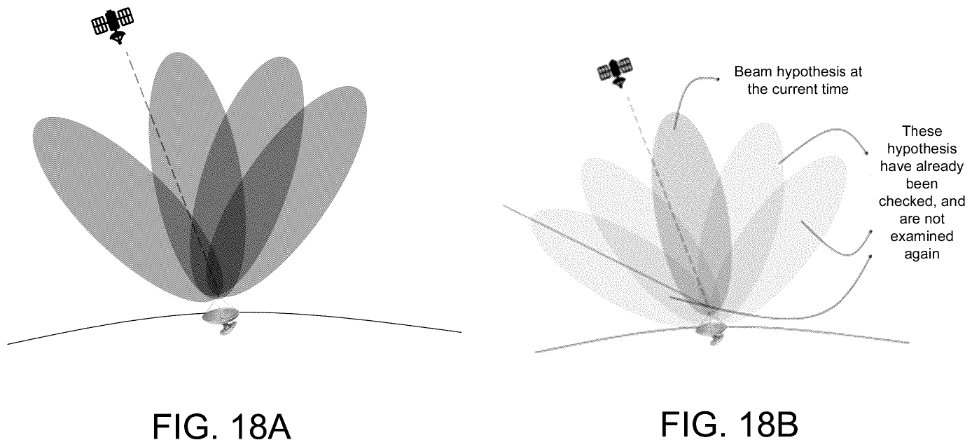

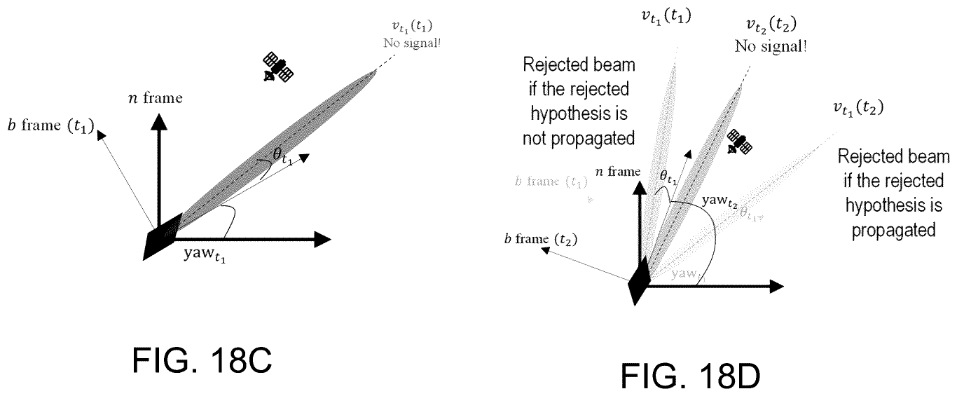

In some embodiments, the re-acquisition engine uses multiple simultaneous hypotheses from the hypothesis space and checks them simultaneously by forming multiple beams where each beam is formed based on an orientation hypothesis. FIG. 18A illustrates an example of non-redundant searching performed by some embodiments of a re-acquisition engine using multiple simultaneous hypotheses from the hypothesis space and checks them simultaneously by forming multiple beams where each beam is formed based on an orientation hypothesis. If the energy is not detected in any of the simultaneous beams formed from the current subset of orientation hypotheses, a new subset is drawn upon which new subsets of beams are formed and this process continues until energy is detected. The beamforming can be analog or digital. In the digital case, upon detecting energy, the re-acquisition engine immediately knows which orientation corresponds to which beam, and hence, no further search is required. In the analog case, the re-acquisition engine only knows that the satellite energy was funneled through one of the beams, and the re-acquisition engine uses a second narrower search within that subset to resolve which beam was associated with the energy that had been detected. In some embodiments, the re-acquisition engine performs the narrower search by sequentially forming individual beams towards each orientation hypothesis inside the last orientation hypotheses set that yielded high energy. FIG. 18A illustrates performing a narrower search by generating multiple beams toward the orientation hypothesis that is within the last orientation hypothesis set.

In some other embodiments, the re-acquisition engine performs a non-redundant search in which the re-acquisition algorithm does not check the orientation hypotheses that were rejected in previous searches and treats them as impossible states of the terminal. Limiting the search in this way is useful because checking a new direction costs time due to non-zero beam-tuning latency of the antennas, as well as the time needed to dwell the beam at a given direction in order to obtain a reliable metric (based on which rejection or acceptance of the hypothesis will be utilized). FIG. 18B illustrates an example of non-redundant searching performed by some embodiments of a re-acquisition engine. Referring to FIG. 18B, the middle beam is the beam hypothesis at the current time, while the other beams on the outside of the middle beam are the beam hypothesis that have already been checked and are not examined again.

In some embodiments, the re-acquisition engine uses gyroscope readings to propagate the rejected hypotheses forward in time to compensate for terminal motion while searching. This is to adhere with the principle of a Mutually Exclusive, Collectively Exhaustive (MECE) search. Note that not doing so might result in a good hypothesis leaking into rejected hypotheses, thereby resulting in a situation where the satellite is never found. FIGS. 18C and 18D illustrate this idea.

Referring to FIG. 18C, the body frame and the navigation frame at time t₁ are shown, and the beam is pointed towards a direction where there is no satellite/signal. This is denoted by vₜ_{₁}(t₁). As time passes by to t₂, due to rotation of the terminal, the body frame moves to a new position with respect to the navigation frame. This is shown in FIG. 18D for time t₂. The direction that was already searched has a different position in the body frame at time t₂, which is denoted by vₜ_{₁}(t₂). Therefore, in some embodiments, to guarantee the mutually exclusive component of MECE principle (i.e., to avoid a redundant search), the excluded pointing vector vₜ_{₁}(t₁) is updated to vₜ_{₁}(t₂). On the other hand, not propagating vector vₜ_{₁}(t₁) and only adding it to the exclusion list (which has an underlying assumption that there is a lack of rotation) violates the “collectively exhaustive” principle as a hypothesis might be skipped that was never searched previously.

In some embodiments, the re-acquisition engine uses a clock/counter and a gyroscope to propagate the rejected hypotheses forward in time to adhere with the principle of MECE. In some other embodiments, the re-acquisition engine is able to handle the problem of propagating hypotheses with a non-ideal gyroscope. In this case, due to presence of gyro noise, gyro bias, and misalignment, the re-acquisition engine does not propagate the rejected hypotheses forward with complete fidelity. This might result in a few bad hypotheses leaking into good (but yet unfound) hypothesis space and vice versa and can be a recurring incidence in cases where the search time becomes longer than normal. In some embodiments, the re-acquisition engine uses an elimination mechanism which allows some older rejected hypothesis to be randomly eliminated from the rejection set so as to not deprive the search algorithm from never finding the satellite due to an imperfect leakage problem.

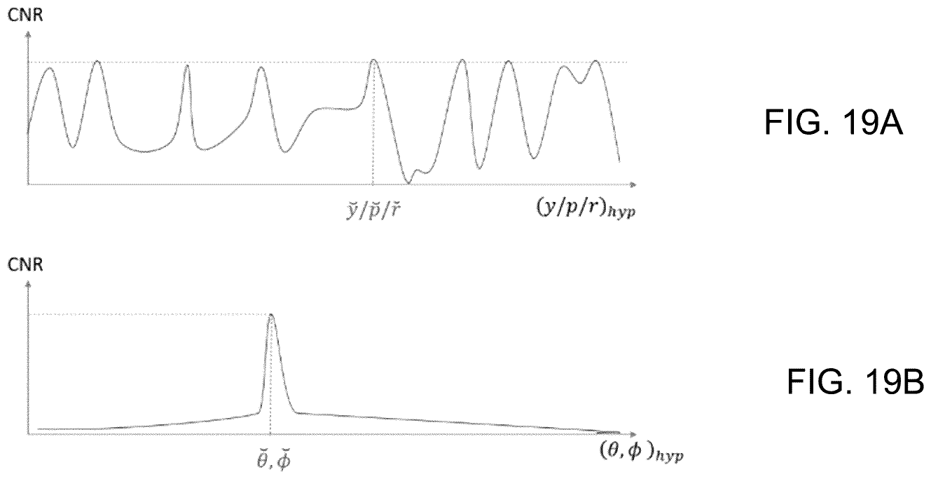

In some embodiments, the re-acquisition engine performs an intentional widening of the search uncertainty with the goal of exploiting the many-to-one relationship that exists between the orientation domain and the pointing domain. FIGS. 19A and 19B illustrate this idea. In both FIGS. 19A and 19B, for the sake of illustration, the multi-dimensional space has been oversimplified with only a single axis. In FIG. 19A, the three-dimensional orientation domain (y/p/r) is shown on a single x-axis, whereas in FIG. 19B, the pointing angles (θ/ϕ) in body frame is shown on x-axis. While, in the body frame, there is only one hypothesis (denoted by θ̆/ϕ̆) that lands the beam on the satellite (gauged by the higher carrier to noise ratio (CNR)), there could be many y/p/r hypotheses in the orientation search domain that yield the same result. This notion is illustrated in FIG. 19A with the many peaks achieving high CNR. Of course, only one of the peaks corresponds to the true orientation of the terminal (denoted by y̆/p̆/r̆). However, as searching in the orientation domain has been described, in some embodiments, the goal is not to find the true orientation hypothesis. Therefore, through fictitious widening of the search uncertainty, it is made possible to expose the search algorithm to many distinct search locations that land the beam on the satellite.

In some embodiments, the re-acquisition engine shrinks the search space once a good hypothesis was found. In this case, the re-acquisition engine maintains a set of acceptance hypotheses having members that are checked against any new hypothesis drawn at the current time before being tested (through forming a beam). In the event that the drawn hypothesis does not lie close to any of the members inside the acceptance set, the re-acquisition engine won't test the drawn hypothesis. Alternatively, if the drawn hypothesis lies close to at least one member of the acceptance set, the re-acquisition engine uses this hypothesis as the new candidate hypothesis to be tested. This helps in reducing the search time and facilitating the search process.

In some embodiments, the re-acquisition engine uses a gyroscope and a clock to propagate the accepted hypothesis inside the acceptance hypotheses set forward in time to compensate for terminal motion while searching. Similar to updating the rejection set, if the gyroscope is non-ideal, the re-acquisition engine uses an elimination mechanism to remove older accepted hypotheses with the goal of not leaking a bad hypothesis into the acceptance hypothesis set due to the gyroscope being non-ideal.

In some embodiments, the re-acquisition engine uses the rejected and accepted hypotheses sets to update the orientation belief that sensor fusion engine is trying to maintain (and which re-acquisition engine is trying to exploit) while the search is in progress. This makes the relationship between acquisition engine and sensor fusion engine a reciprocal one where the information flows bidirectionally between the two to update the beliefs on both sides. This is beneficial as the sensor fusion engine, during acquisition, is running independent of one of its most important sensory information (namely closed-loop).

In some embodiments, the re-acquisition engine forms beams with adaptively adjustable beamwidth to accelerate the search time and reduce the outage time. Concretely, at the beginning of search where uncertainty is high, in some embodiments, the re-acquisition engine choses a wider beam to accelerate the search. But as more data becomes available (e.g., by inspecting the growing acceptance hypotheses set), the re-acquisition engine shrinks the beamwidth of the candidate beam to be able to collect a more reliable metric within a shorter dwelling time.

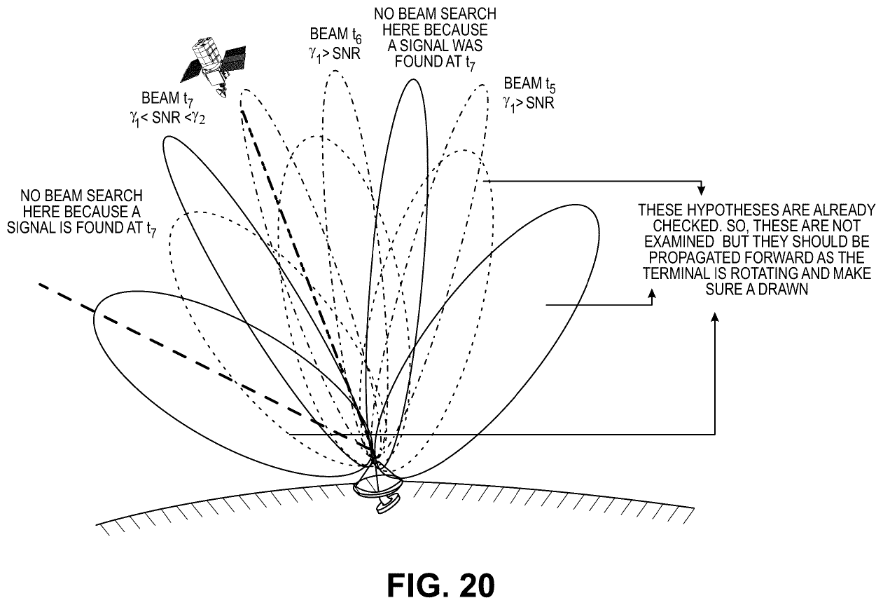

FIG. 20 illustrates this hierarchical adaptation of beam characteristic. Referring to FIG. 20, a beam search is performed in a narrower area where hypotheses have not already been checked. In this case, during the search of this narrower search space, a signal is found at t7. A beam search is not performed in certain areas because a signal was found at t7. Certain hypotheses have already been checked and so those are not examined again. Even so, these are propagated forward as the terminal is rotating.

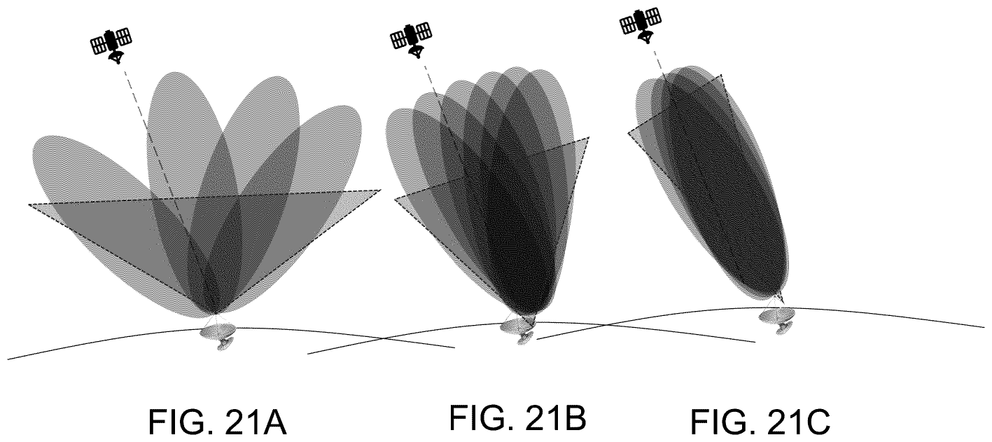

In some embodiments, the re-acquisition engine adaptively adjusts the beam stride as more data becomes available about the possible directions of the satellite. More specifically, at the beginning of the search where little is known about the true satellite direction, in some embodiments, with the next hypothesis potentially being arbitrarily away from the previous accepted hypothesis inside the acceptance hypotheses, as the re-acquisition engine gains confidence about certain directions, the re-acquisition engine bounds the beam stride. Note that this is different from the above use of adaptive beamwidths as, in this case, the beamwidth of the hypothesized beams at different times can be fixed but their boresight location becomes more restricted to avoid unnecessary jumping and searching. FIGS. 21A, B, and C illustrate this feature.

There are a number of example embodiments described herein.

Example 1 is an apparatus comprising: a flat-panel antenna; and a signal processing engine communicably coupled to the flat-panel antenna configured to process asynchronous sensory inputs from a plurality of sensors, and generate estimates of a state of a flat-panel antenna of the satellite antenna terminal based on the sensory inputs, the estimates including an estimate of the orientation.

Example 2 is the apparatus of example 1 that may optionally include that the state comprises one or more of angular velocity, angular acceleration, linear acceleration, linear velocity, position, gyroscope bias, gyroscope noise statistics, accelerometer bias, accelerometer noise statistics, and accuracy indications regarding positional sensor.

Example 3 is the apparatus of example 1 that may optionally include that the signal processing engine is configured to generate the estimate of the orientation based on one or more of a velocity vector, positional vector, a differential position vector, and a differential velocity vector.

Example 4 is the apparatus of example 1 that may optionally include that the signal processing engine comprises: a core engine to generate the estimates; and a pre-processor to receive the sensory inputs and determine which sensor measurements to send to the core engine for selecting by the core engine to use in generating the estimates.

Example 5 is the apparatus of example 4 that may optionally include that the core

engine comprises an iterative processing engine.

Example 6 is the apparatus of example 5 that may optionally include that the iterative processing engine comprises a Kalman filter to estimate the unknown states associated with the flat-panel antenna.

Example 7 is the apparatus of example 5 that may optionally include that the iterative processing engine comprises: a first Kalman filter to estimate the state of the flat-panel antenna; and an iterator coupled to the first Kalman filter to cause the first Kalman filter to iterate on the sensory inputs along with any new sensor input data received since a previous iteration.

Example 8 is the apparatus of example 5 that may optionally include that the core engine comprises: an orientation initializer to provide an initial orientation estimate; and a gyro bias initializer to infer gyro bias and provide an initial bias indication for a gyro associated with the flat-panel antenna.

Example 9 is the apparatus of example 4 that may optionally include that the pre-processor is configured to determine which sensory measurements to send to the core engine by detecting one or more faulty sensors of the plurality of sensors and outlier data from any sensors of the plurality of sensors and determining whether the flat-panel antenna was in a stationary interval with respect to rotation when the sensory measurements were made.

Example 10 is the apparatus of example 9 that may optionally include that the pre-processor determines that the flat-panel antenna was in the stationary interval based on historical gyro measurements and differential position and velocity vectors.

Example 11 is the apparatus of example 4 that may optionally include a post-processor coupled to the core engine to: receive the estimates generated by the core engine; determine estimates comply with expected behavior; and output estimates determined to comply with the expected behavior.

Example 12 is the apparatus of example 1 that may optionally include an acquisition engine coupled to the signal processing engine to perform satellite signal acquisition in response to a loss of satellite tracking, wherein the acquisition engine to select a search space using information related to the estimate of orientation from the signal processing engine.

Example 13 is the apparatus of example 12 that may optionally include that the acquisition engine is configured to generate a plurality of orientation hypotheses related to orientation of the flat-panel antenna and forming multiple beams simultaneously to search for a satellite, where each of the multiple beams is formed based on one of the plurality of hypothesis.

Example 14 is the apparatus of example 12 that may optionally include that the acquisition engine is configured to perform re-acquisition by repeatedly narrowing the search space, including preventing beam formation for an orientation hypothesis previously determined to be a non-likely state of the terminal.

Example 15 is the apparatus of example 12 that may optionally include that the acquisition engine is configured to perform re-acquisition by reducing the search space by determining whether to include individual orientation hypothesis based on a comparison between one or more orientation hypotheses previously determined as acceptable for searching.

Example 16 is the apparatus of example 12 that may optionally include that the acquisition engine is configured to provide the signal processing engine with an indication of both non-acceptable and acceptable orientation hypotheses, and further wherein the signal processing engine to update the orientation estimate based on the non-acceptable and acceptable orientation hypotheses.

Example 17 is the apparatus of example 12 that may optionally include that the acquisition engine is configured to adaptively adjust beamwidth for beams being used to search for a satellite as multiple sets of searches are performed, wherein the acquisition engine is configured to narrow the beamwidth as a subsequent search set is performed.

Example 18 is the apparatus of example 12 that may optionally include that the acquisition engine is configured to bound beam stride as more searches of the search space occur.

Example 19 is the apparatus of example 1 that may optionally include that the flat-panel antenna comprises a metasurface antenna.

Example 20 is a method comprising: processing asynchronous sensory inputs from a plurality of sensors and generating estimates of a state of a flat-panel antenna of the satellite antenna terminal based on the sensory inputs, the estimates including an estimate of the orientation.

Example 21 is the method of example 20 that may optionally include that the state comprises one or more of angular velocity, angular acceleration, linear acceleration, linear velocity, position, gyroscope bias, gyroscope noise statistics, accelerometer bias, accelerometer noise statistics, and accuracy indications regarding positional sensor.

Example 22 is the method of example 20 that may optionally include that generating the estimate of the orientation is based on one or more of a velocity vector, positional vector, a differential position vector, and a differential velocity vector.

Example 23 is the method of example 20 that may optionally include performing satellite signal acquisition in response to a loss of satellite tracking, wherein performing satellite signal acquisition comprises selecting a search space using information related to the estimate of orientation from the signal processing engine.

Example 24 is the method of example 20 that may optionally include generating a plurality of orientation hypotheses related to orientation of the flat-panel antenna and forming multiple beams simultaneously to search for a satellite, where each of the multiple beams is formed based on one of the plurality of hypotheses.

Example 25 is the method of example 20 that may optionally include that performing re-acquisition comprises repeatedly narrowing the search space, by preventing beam formation for an orientation hypothesis previously determined to be a non-likely state of the terminal, or determining whether to include individual orientation hypothesis based on a comparison between one or more orientation hypotheses previously determined as acceptable for searching.

Example 26 is the method of example 20 that may optionally include that performing re-acquisition comprises adaptively adjusting beamwidth for beams being used to search for a satellite as multiple sets of searches are performed, wherein the acquisition engine is configured to narrow the beamwidth as a subsequent search set is performed.

Example 27 is one or more non-transitory computer readable storage media having instructions stored thereupon which, when executed by a satellite terminal having at least a signal processing engine and a memory therein, cause the signal processing engine to perform operations comprising: processing asynchronous sensory inputs from a plurality of sensors, and generating estimates of a state of a flat-panel antenna of the satellite antenna terminal based on the sensory inputs, the estimates including an estimate of the orientation.

Example 28 is the one or more non-transitory computer readable storage media of example 27 that may optionally include that the state comprises one or more of angular velocity, angular acceleration, linear acceleration, linear velocity, position, gyroscope bias, gyroscope noise statistics, accelerometer bias, accelerometer noise statistics, and accuracy indications regarding positional sensor.

Example 29 is the one or more non-transitory computer readable storage media of example 27 that may optionally include that generating the estimate of the orientation is based on one or more of a velocity vector, positional vector, a differential position vector, and a differential velocity vector.

Methods and tasks described herein can be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

1. An apparatus comprising:
a flat-panel antenna; and
a signal processing engine communicably coupled to the flat-panel antenna configured to
process asynchronous sensory inputs from a plurality of sensors, and
generate estimates of a state of a flat-panel antenna of the satellite antenna terminal based on the sensory inputs, the estimates including an estimate of the orientation.

2. The apparatus of claim 1 wherein the state comprises one or more of angular velocity, angular acceleration, linear acceleration, linear velocity, position, gyroscope bias, gyroscope noise statistics, accelerometer bias, accelerometer noise statistics, and accuracy indications regarding positional sensor.

3. The apparatus of claim 1 wherein the signal processing engine is configured to generate the estimate of the orientation based on one or more of a velocity vector, positional vector, a differential position vector, and a differential velocity vector.

4. The apparatus of claim 1 wherein the signal processing engine comprises:
a core engine to generate the estimates; and
a pre-processor to receive the sensory inputs and determine which sensor measurements to send to the core engine for selecting by the core engine to use in generating the estimates.

5. The apparatus of claim 4 wherein the core engine comprises an iterative processing engine.

6. The apparatus of claim 5 wherein the iterative processing engine comprises a Kalman filter to estimate the unknown states associated with the flat-panel antenna.

7. The apparatus of claim 5 wherein the iterative processing engine comprises:
a first Kalman filter to estimate the state of the flat-panel antenna; and
an iterator coupled to the first Kalman filter to cause the first Kalman filter to iterate on the sensory inputs along with any new sensor input data received since a previous iteration.

8. The apparatus of claim 5 wherein the core engine comprises:
an orientation initializer to provide an initial orientation estimate; and
a gyro bias initializer to infer gyro bias and provide an initial bias indication for a gyro associated with the flat-panel antenna.

9. The apparatus of claim 4 wherein the pre-processor is configured to determine which sensory measurements to send to the core engine by detecting one or more faulty sensors of the plurality of sensors and outlier data from any sensors of the plurality of sensors and determining whether the flat-panel antenna was in a stationary interval with respect to rotation when the sensory measurements were made.

10. The apparatus of claim 9 wherein the pre-processor determines that the flat-panel antenna was in the stationary interval based on historical gyro measurements and differential position and velocity vectors.

11. The apparatus of claim 4 further comprising a post-processor coupled to the core engine to:
receive the estimates generated by the core engine;
determine estimates comply with expected behavior; and
output estimates determined to comply with the expected behavior.

12. The apparatus of claim 1 further comprising an acquisition engine coupled to the signal processing engine to perform satellite signal acquisition in response to a loss of satellite tracking, wherein the acquisition engine to select a search space using information related to the estimate of orientation from the signal processing engine.

13. The apparatus of claim 12 wherein the acquisition engine is configured to generate a plurality of orientation hypotheses related to orientation of the flat-panel antenna and forming multiple beams simultaneously to search for a satellite, where each of the multiple beams is formed based on one of the plurality of hypotheses.

14. The apparatus of claim 12 wherein the acquisition engine is configured to perform re-acquisition by repeatedly narrowing the search space, including preventing beam formation for an orientation hypothesis previously determined to be a non-likely state of the terminal.

15. The apparatus of claim 12 wherein the acquisition engine is configured to perform re-acquisition by reducing the search space by determining whether to include an individual orientation hypothesis based on a comparison between one or more orientation hypotheses previously determined as acceptable for searching.

16. The apparatus of claim 12 wherein the acquisition engine is configured to provide the signal processing engine with an indication of both non-acceptable and acceptable orientation hypotheses, and further wherein the signal processing engine is configured to update the orientation estimate based on the non-acceptable and acceptable orientation hypotheses.

17. The apparatus of claim 12 wherein the acquisition engine is configured to adaptively adjust beamwidth for beams being used to search for a satellite as multiple sets of searches are performed, wherein the acquisition engine is configured to narrow the beamwidth as a subsequent search set is performed.

18. The apparatus of claim 12 wherein the acquisition engine is configured to bound beam stride as more searches of the search space occur.

19. The apparatus of claim 1 wherein the flat-panel antenna comprises a metasurface antenna.

20. A method comprising:
processing asynchronous sensory inputs from a plurality of sensors, and
generating estimates of a state of a flat-panel antenna of the satellite antenna terminal based on the sensory inputs, the estimates including an estimate of the orientation.

21. The method of claim 20 wherein the state comprises one or more of angular velocity, angular acceleration, linear acceleration, linear velocity, position, gyroscope bias, gyroscope noise statistics, accelerometer bias, accelerometer noise statistics, and accuracy indications regarding positional sensor.

22. The method of claim 20 wherein generating the estimate of the orientation is based on one or more of a velocity vector, positional vector, a differential position vector, and a differential velocity vector.

23. The method of claim 20 further comprising performing satellite signal acquisition in response to a loss of satellite tracking, wherein performing satellite signal acquisition comprises selecting a search space using information related to the estimate of orientation from the signal processing engine.

24. The method of claim 20 further comprising generating a plurality of orientation hypotheses related to orientation of the flat-panel antenna and forming multiple beams simultaneously to search for a satellite, where each of the multiple beams is formed based on one of the plurality of hypotheses.

25. The apparatus of claim 24 wherein performing re-acquisition comprises repeatedly narrowing the search space, by
preventing beam formation for an orientation hypothesis previously determined to be a non-likely state of the terminal, or
determining whether to include individual orientation hypothesis based on a comparison between one or more orientation hypotheses previously determined as acceptable for searching.

26. The apparatus of claim 24 wherein performing re-acquisition comprises adaptively adjusting beamwidth for beams being used to search for a satellite as multiple sets of searches are performed, wherein the acquisition engine is configured to narrow the beamwidth as a subsequent search set is performed.

27. One or more non-transitory computer readable storage media having instructions stored thereupon which, when executed by a satellite terminal having at least a signal processing engine and a memory therein, cause the signal processing engine to perform operations comprising:
processing asynchronous sensory inputs from a plurality of sensors, and
generating estimates of a state of a flat-panel antenna of the satellite antenna terminal based on the sensory inputs, the estimates including an estimate of the orientation.

28. The one or more non-transitory computer readable storage media of claim 27 wherein the state comprises one or more of angular velocity, angular acceleration, linear acceleration, linear velocity, position, gyroscope bias, gyroscope noise statistics, accelerometer bias, accelerometer noise statistics, and accuracy indications regarding positional sensor.

29. The one or more non-transitory computer readable storage media of claim 27 wherein generating the estimate of the orientation is based on one or more of a velocity vector, positional vector, a differential position vector, and a differential velocity vector.
